(19) United States
(12) Patent Application Publication
(10) Pub. No.: US 2026/0214578 A1
(43) Pub. Date: Jul. 23, 2026

(54) METHOD FOR RECEIVING AND TRANSMITTING WAKE-UP SIGNAL AND DEVICE

(71) Applicant: Beijing Xiaomi Mobile Software Co., Ltd., Beijing (CN)

(72) Inventor: Shengxiang GUO, Beijing (CN)

(21) Appl. No.: 19/136,737

(22) PCT Filed: Dec. 7, 2022
(86) PCT No.: PCT/CN2022/137346

§ 371 Date: Jun. 6, 2025

(51) Int. Cl. H04W 52/02

(52) U.S. Cl. CPC H04W 52/0235; H04W 52/0212; H04W 52/028

(57) ABSTRACT

A method and device for receiving and transmitting a wake-up signal are provided. The method for receiving a wake-up signal comprisesis performed by a terminal and includes: receiving a wake-up signal transmitted by a network device; and changing a sleep state of a main radio in the terminal and acquiring scheduling information. According, according to the wake-up signal.

### CROSS-REFERENCE TO RELATED APPLICATION

The present application is a U.S. National Stage of International Application No. PCT/CN 2022/137346, filed on Dec. 7, 2022, the contents of all of which are incorporated herein by reference in their entirety for all purposes.

### BACKGROUND OF THE INVENTION

In a wireless communication system, a power-saving signal, for example, a wake-up signal (WUS), is introduced to a 3rd generation partnership project (3GPP), so as to reduce power of a terminal. The WUS is a type of low power detection signal. In a case where the terminal detects the WUS, a main radio is activated. In a case where the WUS is not received or the WUS indicates no wake-up, the terminal can keep the main radio in a sleep state.

### SUMMARY OF THE INVENTION

The present disclosure relates to the field of communication technology, and in particular, to a method and device for receiving a wake-up signal, and a method and device for transmitting a wake-up signal.

According to a first aspect of embodiments of the present disclosure, a method for receiving a wake-up signal is provided. The method is performed by a terminal and includes:
receiving a wake-up signal transmitted by a network device; and
changing a sleep state of a main radio in the terminal and acquiring scheduling information, according to the wake-up signal.

According to a second aspect of the embodiments of the present disclosure, a method for transmitting a wake-up signal is provided. The method is performed by a network device and includes:
transmitting the wake-up signal to a terminal, where the wake-up signal is configured for the terminal to change a sleep state of a main radio and to acquire scheduling information.

According to a third aspect of the embodiments of the present disclosure, a device for receiving a wake-up signal is provided. The device includes:
a receiving module configured to receive a wake-up signal transmitted by a network device; and
a processing module configured to change a sleep state of a main radio in a terminal and acquire scheduling information, according to the wake-up signal.

According to a fourth aspect of the embodiments of the present disclosure, a device for transmitting a wake-up signal is provided. The device includes:
a transmitting module configured to transmit the wake-up signal to a terminal, where the wake-up signal is configured for the terminal to change a sleep state of a main radio and to acquire scheduling information.

According to a fifth aspect of the embodiments of the present disclosure, a terminal is provided. The terminal includes:
one or more processors; and
a memory configured to store processor-executable instructions;
where the one or more processors are collectively configured to execute the processor-executable instructions so as to implement the method for receiving a wake-up signal according to the first aspect of the present disclosure.

According to a sixth aspect of the embodiments of the present disclosure, a network device is provided. The network device includes:
one or more processors; and
a memory configured to store processor-executable instructions;
where the one or more processors are collectively configured to execute the processor-executable instructions so as to implement the method for transmitting a wake-up signal according to the second aspect of the present disclosure.

According to a seventh aspect of the embodiments of the present disclosure, a communication system is provided. The communication system includes:
a terminal, configured to perform the method for receiving a wake-up signal according to the first aspect of the present disclosure; and
a network device, configured to perform the method for transmitting a wake-up signal according to the second aspect of the present disclosure.

According to an eighth aspect of the embodiments of the present disclosure, a non-transitory computer-readable storage medium is provided. The non-transitory computer-readable storage medium stores computer program instructions, where the computer program instructions, when collectively executed by one or more processors, cause the one or more processors to perform steps of the method for receiving a wake-up signal according to the first aspect of the present disclosure or steps of the method for transmitting a wake-up signal according to the second aspect of the present disclosure respectively.

### BRIEF DESCRIPTION OF DRAWINGS

The above and/or additional aspects and advantages of the present disclosure will be apparent and readily understandable from the following description of embodiments made in conjunction with accompanying drawings.

FIG. 1 is a schematic diagram of a communication system according to an embodiment.

FIG. 2 is a flowchart of a method for receiving a wake-up signal according to an embodiment.

FIG. 3 is a communication timing diagram of a method for receiving a wake-up signal and a method for transmitting a wake-up signal according to another embodiment.

FIG. 4 is a flowchart of a method for receiving a wake-up signal according to another embodiment.

FIG. 5 is a flowchart of a method for receiving a wake-up signal according to yet another embodiment.

FIG. 6 is a flowchart of a method for receiving a wake-up signal according to yet another embodiment.

FIG. 7 is a flowchart of a method for receiving a wake-up signal according to yet another embodiment.

FIG. 8 is a flowchart of a method for receiving a wake-up signal according to yet another embodiment.

FIG. 9 is a flowchart of a method for receiving a wake-up signal according to yet another embodiment.

FIG. 10 is a flowchart of a method for receiving a wake-up signal according to still another embodiment.

FIG. 11 is a flowchart of a method for transmitting a wake-up signal according to an embodiment.

FIG. 12 is a block diagram of a device for receiving a wake-up signal according to an embodiment.

FIG. 13 is a block diagram of a device for transmitting a wake-up signal according to an embodiment.

FIG. 14 is a block diagram of a communication device according to an embodiment.

FIG. 15 is a block diagram of a communication device according to an embodiment.

### DETAILED DESCRIPTION OF THE INVENTION

Examples will be described in detail, and their instances are shown in the accompanying drawings. When the following description involves the accompanying drawings, the same numerals in different accompanying drawings indicate the same or similar elements unless otherwise indicated. Implementations described in the following examples do not represent all implementations consistent with the present disclosure. On the contrary, these implementations are merely instances of devices and methods consistent with some aspects of the present disclosure as detailed in the appended claims.

It is to be noted that all actions for acquiring signals, information or data in the present disclosure are taken on the premise of complying with corresponding data protection laws and policies of the local country and being granted authorization from a corresponding device owner.

The terms “first,” “second,” etc. in the description of the present disclosure are used to distinguish similar objects, but are not necessarily understood as specific sequence or sequential order. In addition, in the description with reference to the accompanying drawings, the same reference numerals in different accompanying drawings indicate the same elements unless otherwise stated.

In the description of the present disclosure, unless otherwise specified, “plurality” indicates two or more, and other similar quantifiers are as follows: “at least one item (piece),” “one item (piece) or more items (pieces)” or other similar expressions refer to any combination of these items (pieces), including any combination of a single item (piece) or plural items (pieces). For example, “at least one item (piece)” can indicate any number. For example, “one item (piece) or more items (pieces) of a, b, and c” can indicate as follows: a, b, c, a-b, a-c, b-c, or a-b-c, and a, b, and c can indicate single or plurality. The term “and/or” is an association relation that describes associated objects, and indicates that three types of relations can exist. For example, “A and/or B” can indicate that A exists alone, A and B exist simultaneously, and B exists alone. A and B can be singular or plural.

Although operations or steps are described in the accompanying drawings in specific order in embodiments of the present disclosure, it is not understood in a way that these operations or steps are required to be performed in shown specific order or in serial order, or that all shown operations are required to be executed for achieving expected results. In the embodiments of the present disclosure, these operations or steps can be performed in series, or these operations or steps can be performed in parallel, or some of these operations or steps can be performed.

A wake-up signal (WUS) plays an important role in a process of waking up the main radio. It is a pressing technical problem to better configure the WUS.

An implementation environment of the embodiment of the present disclosure will be introduced below at first.

The technical solutions of the embodiments of the present disclosure may be applied to various communication systems. The communication system may include one or more of a 4th generation (4G) communication system, a 5th generation (5G) communication system, and another future wireless communication system (such as 6G). The communication system may alternatively include one or more of a public land mobile network (PLMN) network, a device-to-device (D2D) communication system, a machine-to-machine (M2M) communication system, an Internet of Things (IOT) communication system, a vehicle-to-everything (V2X) communication system, or other communication systems.

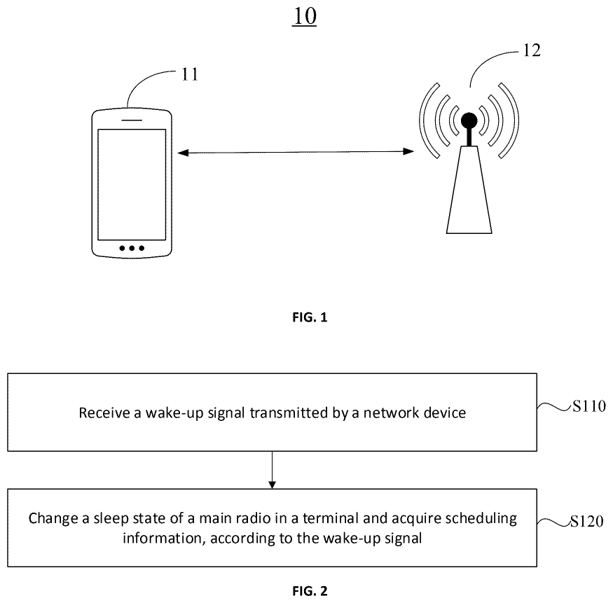

FIG. 1 is a schematic diagram of a communication system according to an example. As shown in FIG. 1, the communication system 10 may include a terminal 11 and a network device 12. The communication system 10 may be configured to support 4G network access technology, such as long term evolution (LTE) access technology, or may be configured to support 5G network access technology, such as new radio access technology (New RAT), or may be configured to support other future wireless communication technologies. It is to be noted that in this communication system 10, a number of the network devices 12 and a number of the terminals 11 may be one or more. The number of the network devices 12 and the number of the terminals 11 in the communication system 10 shown in FIG. 1 are adaptive examples merely, which are not limited by the present disclosure.

The network device 12 in FIG. 1 may be configured to support access of the terminal 11. For example, the network device 12 may be an evolutional Node B (eNB or eNodeB) in long term evolution (LTE). The network device 12 may alternatively be the next generation Node B (gNB or gNodeB) in a 5G network. The network device 12 may alternatively be an NG radio access network (NG-RAN) device in the 5G network. The network device 12 may alternatively be a base station, a broadband network gateway (BNG), an aggregation switch, or a non-3rd generation partnership project (3GPP) access device in a future evolved public land mobile network (PLMN).

In an example, the network device 12 may include various forms of base stations, such as a macro base station, a micro base station (or referred to as a small base station), a relay station, an access point, a 5G base station or a future base station, a satellite, a transmitting and receiving point (TRP), a transmitting point (TP), a mobile switching center, and a device that undertakes the function of the base station in device-to-device (D2D) communication, machine-to-machine (M2M) communication, Internet of Things (IOT) communication, vehicle-to-everything (V2X) communication, or other communication, etc., which are not limited in the embodiment of the present disclosure. For convenience of description, in all embodiments of the present disclosure, devices providing a wireless communication function for the terminal 11 are collectively referred to as the network device 12 or the base station.

The terminal 11 in FIG. 1 may be an electronic device providing voice or data connectivity. For example, the terminal 11 may alternatively be referred to as user equipment (UE), a subscriber unit, a mobile station, a station, and a terminal. For example, the terminal 11 may include a smart phone, a smart wearable device, a smart speaker, a smart portable android device, a radio modem, a wireless local loop (WLL) station, a personal digital assistant (PDA), and customer premise equipment (CPE), etc. With the development of the wireless communication technology, devices that may access the communication system, communicate with a network device in the communication system, or communicate with other objects through the communication system, or devices that may communicate directly between two or more devices may all be the terminals 11 in the embodiment of the present disclosure, for example, a terminal and an automobile in intelligent transportation, a household device in a smart home, a power meter reading instrument in a smart grid, a voltage monitoring instrument, an environmental monitoring instrument, a video monitoring instrument in an intelligent security network, and a cash register. In an embodiment of the present disclosure, the terminal 11 may communicate with the network device 12. A plurality of the terminals 11 may further communicate with one another. The terminal 11 may be statically fixed or mobile, which is not limited by the present disclosure.

In an embodiment, the terminal 11 in FIG. 1 may be a terminal supporting a power saving function. The terminal 11 may include a low power (LP) wake-up receiver (WUR) and a main radio (MR). The wake-up receiver may be referred to as LP-WUR. For example, the main radio may be in different degrees of sleep states in a case where the terminal 11 has no data transmission and reception. In an implementation, the sleep state of the terminal 11 may include one or more of ultra-deep sleep, deep sleep, light sleep, and micro sleep. Time to wake up the main radio of the terminal 11 from different sleep states varies. In addition, due to different capacities of hardware or software of the terminal 11, time to wake up different terminals 11 from a same sleep state also varies.

It is to be noted that the terminal 11 may be in a wake-up state after being waken up. The wake-up state of the terminal 11 may be considered as a different state relative to the sleep state, or may be considered as a special form of the sleep state, which is not limited in the present disclosure.

It is to be noted that the main radio may include at least one of a main transceiver or a main receiver. One or more main transceivers may be provided, and one or more main receivers may also be provided.

The terminal 11 in FIG. 1 may support reception of a low-power wake-up signal (WUS).

In an embodiment, the terminal 11 may receive the WUS using the main radio (at least one of the main transceiver or the main receiver).

In another embodiment, the terminal 11 may use a separate receiver to receive the WUS, and use the main transceiver to receive a downlink signal and to transmit an uplink signal, or may use the main receiver to receive a downlink signal. At least one of the main receiver or the main transceiver may be referred to as the main radio of the terminal 11. In a case where the terminal 11 receives the WUS that instructs the terminal 11 to wake up, the terminal 11 may activate the main transceiver for transmitting and receiving and processing downlink/uplink information, or may activate the main receiver for receiving and processing downlink information. In a case where the WUS is not received, or the WUS instructs no wake-up, the terminal 11 may keep the sleep state of at least one of the main transceiver or the main receiver. The WUS may be applied to any state of the terminal 11, such as a radio resource control (RRC) connected state, an RRC idle state, or an RRC deactivated state.

At a non-scheduled moment, the main radio is in the sleep state, such that the terminal in this case may not know changes of network environment and service scheduling with the passage of time. For example, during monitoring of the LP WUS, when a large data packet arrives, the network device needs to initiate transmission of the data packet immediately after waking up the terminal. However, since the terminal is merely configured with a small bandwidth before going to sleep, a requirement for service transmission is difficult to satisfy, such that an entire transmission process is caused to be longer than on duration of discontinuous reception (DRX) configured for the terminal. For another example, a number of multiple-input multiple-output (MIMO) layers is adaptive, and the number of the MIMO layers changes correspondingly along with a change of beam information.

FIG. 2 is a flowchart of a method for receiving a wake-up signal according to an embodiment. As shown in FIG. 2, the method may be performed by a terminal and include steps S110 and S120.

Step S110 includes receiving a wake-up signal transmitted by a network device.

In an embodiment of the present disclosure, the terminal may use a main radio (at least one of a main transceiver or a main receiver) to receive the wake-up signal. The wake-up signal may be a low power wake-up signal (LP WUS), and may be configured to change a sleep state of the main radio in the terminal. The wake-up signal may be a message transmitted by the network device.

Step S120 includes changing the sleep state of the main radio in the terminal and acquiring scheduling information, according to the wake-up signal.

Through the introduction described in the disclosure, the wake-up state of the terminal may be considered as a different state relative to the sleep state, or may be considered as a special form of the sleep state. The sleep state may include an ultra-deep sleep state, a deep sleep state, a light sleep state, and a micro sleep state.

In an embodiment of the present disclosure, the terminal may include the main radio (MR) and a wake-up receiver (WUR). The terminal may use the wake-up receiver (WUR) to monitor and receive a wake-up packet (WUP) for waking up the MR in the sleep state. In a case where the wake-up packet received by the WUR is to wake up a MR associated with the WUR, the WUR changes the sleep state of the MR through an internal association mechanism.

As an instance, after the terminal receives a first wake-up signal, the terminal may change the sleep state of the terminal to the wake-up state. As another instance, after the terminal receives a second wake-up signal, the terminal may change the sleep state of the terminal from a deep sleep state to a micro sleep state.

In some implementations, the terminal may acquire the scheduling information from the wake-up signal. The scheduling information may include at least one of power control information, bandwidth part indication information, cell deactivation information, reference signal request information, multiple-input multiple-output (MIMO) layer indication information, cancel information, or cross-slot scheduling indication information.

In the embodiment of the present disclosure, the terminal may acquire, according to the wake-up signal, parameter configuration related to scheduling. That is, the scheduling information in the wake-up signal may include a plurality of parameters related to the scheduling. Thus, a pre-configuration requirement may be realized through the wake-up signal. Since the wake-up signal may carry more information bits, the embodiment of the present disclosure can effectively reduce a transmission number of downlink control information (DCI) by pre-configuring through the wake-up signal. In addition, a parameter configured by RRC signaling may also be pre-configured through the wake-up signal, thus shortening an entire scheduling delay.

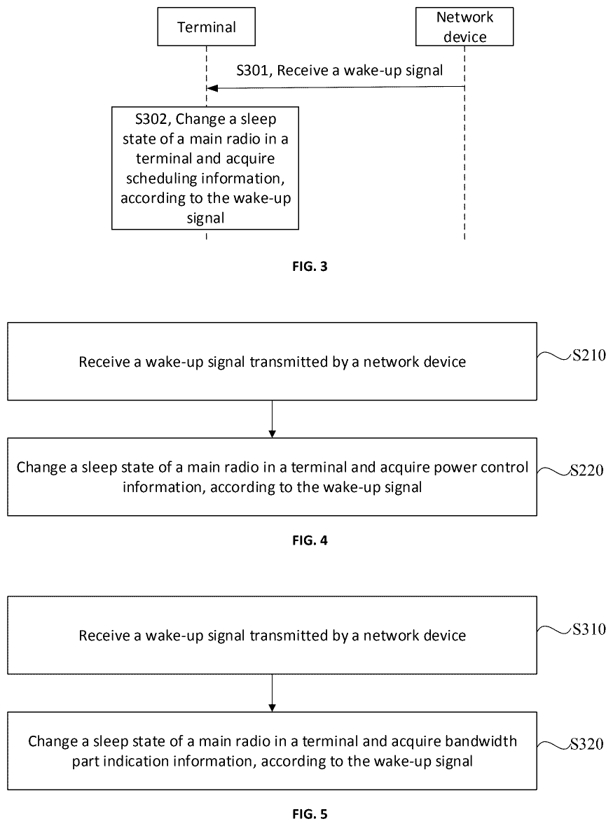

FIG. 3 is a communication timing diagram of a method for receiving a wake-up signal and a method for transmitting a wake-up signal according to an embodiment. As shown in steps S301 and S302 of FIG. 3, a terminal may receive a wake-up signal from a network device, and on this basis, the terminal may change a sleep state of a main radio in the terminal and acquire scheduling information, according to the wake-up signal.

According to the embodiment of the present disclosure, after the wake-up signal is received, the present disclosure can change the sleep state of the main radio in the terminal according to the wake-up signal, and can acquire the scheduling information from the wake-up signal. In this way, an entire scheduling delay is shortened.

FIG. 4 is a flowchart of a method for receiving a wake-up signal according to another embodiment. As shown in FIG. 4, the method may be performed by a terminal and include steps S210 and S220.

Step S210 includes receiving a wake-up signal transmitted by a network device.

Reference can be made to the introduction of the above-described embodiment for the implementation of step S210, which will not be repeated here.

Step S220 includes changing a sleep state of a main radio in the terminal and acquiring power control information, according to the wake-up signal.

In an embodiment of the present disclosure, the terminal may acquire the power control information according to the wake-up signal, and the power control information may be configured to indicate transmission power of an uplink channel.

In an implementation, the power control information may be configured to indicate transmission power of a physical uplink control channel (PUCCH). That is, the terminal may acquire the transmission power of the PUCCH according to the wake-up signal.

In another implementation, the power control information may be configured to indicate transmission power of a physical uplink shared channel (PUSCH). That is, the terminal may acquire the transmission power of the PUSCH according to the wake-up signal.

In an implementation, the power control information may be configured to indicate transmission power of the PUCCH and transmission power of the PUSCH. That is, the terminal may acquire the transmission power of the PUCCH and the transmission power of the PUSCH according to the wake-up signal.

In an example, the terminal may acquire a transmission control protocol (TCP) instruction for at least one of the PUCCH or the PUSCH according to the wake-up signal. The TCP instruction may be the power control information. In an embodiment of the present disclosure, bit information occupied by the power control information may equal five values of 0, 1, 2, 3 or 4.

It is to be noted that in a case where a plurality of embodiments or features are separated by “OR,” even if some of the features are not implementable, other embodiments or features will not be affected. In addition, in a case of no conflict, the embodiment of the present disclosure may be combined with other embodiments or implementations related to the method for receiving a wake-up signal for the terminal and their various optional solutions, which will not be repeated here.

In addition, the wake-up signal in the embodiment of the present disclosure may be a low-power wake-up signal, that is, an LP WUS.

According to the embodiment of the present disclosure, after the wake-up signal is received, the present disclosure can change the sleep state of the main radio in the terminal according to the wake-up signal, and can acquire the scheduling information from the wake-up signal. In this way, an entire scheduling delay is shortened. In addition, the embodiment of the present disclosure may acquire the power control information from the wake-up signal, such that the scheduling information related to the power control information can be pre-configured, and time for scheduling the power control information can be saved.

FIG. 5 is a flowchart of a method for receiving a wake-up signal according to yet another embodiment. As shown in FIG. 5, the method may be performed by a terminal and include steps S310 and S320.

Step S310 includes receiving a wake-up signal transmitted by a network device.

Reference can be made to the introduction of the above-described embodiment for the implementation of step S310, which will not be repeated here.

Step S320 includes changing a sleep state of a main radio in the terminal and acquiring bandwidth part indication information, according to the wake-up signal.

In an embodiment of the present disclosure, the terminal may acquire the bandwidth part (BWP) indication information according to the wake-up signal. A target indicated by the bandwidth part indication information may be an uplink bandwidth part, a downlink bandwidth part, or the uplink bandwidth part and the downlink bandwidth part. In other words, the target indicated by the bandwidth part indication information may be at least one of the uplink bandwidth part or the downlink bandwidth part.

In some implementations, at least one of a number of the uplink bandwidth parts or a number of the downlink bandwidth parts may be M. In an implementation, the M bandwidth parts may include an initial bandwidth part. In an example, the M bandwidth parts may not include the initial bandwidth part.

In an example, bits of the bandwidth part indication information may be 0, 1, 2, 3, 4, or 5. The bits of the bandwidth part indication information may be determined by a number of BWPs of a down link configured by an upper layer.

In some implementations, the bandwidth part indication information may be an n-bit resource unit bitmap. Each bit of the bitmap may correspond to one configured bandwidth part. The n bits sequentially correspond to a first configured bandwidth part to a last configured bandwidth part from a most significant bit to a least significant bit. A bit value of 0 indicates that the bandwidth part is deactivated, and a bit value of 1 indicates that the bandwidth part is reserved. Alternatively, a bit value of 1 indicates that the bandwidth part is deactivated, and a bit value of 0 indicates that the bandwidth part is reserved. Alternatively, a bit value of 0 indicates that the bandwidth part is activated, and a bit value of 1 indicates that the bandwidth part is not activated. Alternatively, a bit value of 1 indicates that the bandwidth part is activated, and a bit value of 0 indicates that the bandwidth part is not activated.

In an embodiment of the present disclosure, a value range of each of n, m, N, and k may be [0,16], that is, the values of n, m, N, and k may be integers not less than 0.

As an instance, a first bandwidth part and a second bandwidth part are configured for the terminal, and the bandwidth part indication information is a 2-bit bitmap. A first bit from a most significant bit to a least significant bit of the bitmap represents the first bandwidth part, and a second bit from a most significant bit to a least significant bit of the bitmap represents the second bandwidth part. In a case where the bitmap is 01, the first bandwidth part is deactivated and the second bandwidth part is reserved.

In another implementation, the bandwidth part indication information may be an m-bit bandwidth composite index, and a decimal value of the m bits may correspond to the bandwidth composite index. The bandwidth composite index may correspond to at least one configured bandwidth part. The bandwidth part indicated by the bandwidth part indication information is deactivated and other bandwidth parts are reserved. Alternatively, the bandwidth part indicated by the bandwidth part indication information is activated and other bandwidth parts are not activated.

As an instance, the bandwidth part indication information is 2 bits, 00 corresponds to an index value of 0, 01 corresponds to an index value of 1, 10 corresponds to an index value of 2, and 11 corresponds to an index value of 3. The network device configures two bandwidth parts for the terminal. The index value of 0 corresponds to a first bandwidth part, the index value of 1 corresponds to a second bandwidth part, the index value of 2 corresponds to the first bandwidth part and the second bandwidth part, and the index value of 3 corresponds to the first bandwidth part, the second bandwidth part, and a third bandwidth part. The bandwidth part indication information being 00 and the index value being 0 indicate that the first bandwidth part is deactivated.

In another implementation, the bandwidth part indication information may be an N-bit resource unit bitmap, and N indicates a maximum number of bandwidth parts configured for the terminal. In an example, first k of N bits may sequentially correspond to a first actually configured bandwidth part to a last actually configured bandwidth part from a most significant bit to a least significant bit. The N is not less than the k. That is, k may equal N to the greatest extent.

The embodiments may be independent of one another or may be combined with one another. Whether the bandwidth part indication information is the resource unit bitmap or the bandwidth composite index is not explicitly limited in the disclosure, but may be determined according to an actual situation. In addition, the parameters n, m, N and k are merely examples and are not limited.

In an embodiment of the present disclosure, the bandwidth part indication information may be configured through RRC signaling or dynamic signaling.

It is to be noted that in a case where a plurality of embodiments or features are separated by “OR,” even if some of the features are not implementable, other embodiments or features will not be affected. In addition, in a case of no conflict, the embodiment of the present disclosure may be combined with other embodiments or implementations related to the method for receiving a wake-up signal for the terminal and their various optional solutions, which will not be repeated here.

In addition, the wake-up signal in the embodiment of the present disclosure may be a low-power wake-up signal, that is, an LP WUS.

According to the embodiment of the present disclosure, after the wake-up signal is received, the present disclosure can change the sleep state of the main radio in the terminal according to the wake-up signal, and can acquire the scheduling information from the wake-up signal. In this way, an entire scheduling delay is shortened. In addition, the embodiment of the present disclosure may acquire the bandwidth part indication information from the wake-up signal, such that the scheduling information related to the bandwidth part indication information can be pre-configured, and time for scheduling the bandwidth part indication information can be saved.

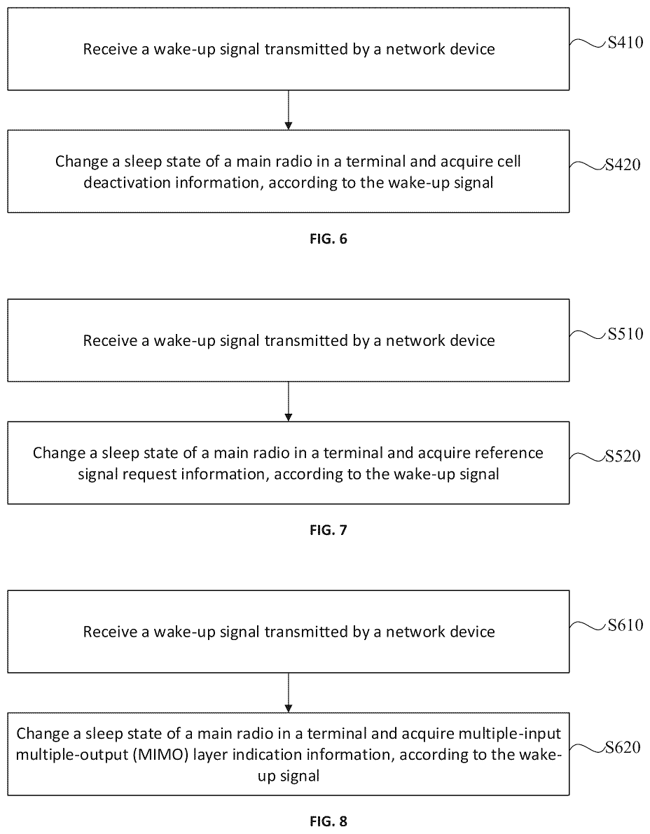

FIG. 6 is a flowchart of a method for receiving a wake-up signal according to yet another embodiment. As shown in FIG. 6, the method may be performed by a terminal and include steps S410 and S420.

Step S410 includes receiving a wake-up signal transmitted by a network device.

Reference can be made to the introduction of the above-described embodiment for the implementation of step S410, which will not be repeated here.

Step S420 includes changing a sleep state of a main radio in the terminal and acquiring cell deactivation information, according to the wake-up signal.

In an embodiment of the present disclosure, the terminal may acquire the cell deactivation information from the wake-up signal. A cell in the cell deactivation information may be a primary cell (PCell), a secondary cell (SCell), a primary secondary cell (PSCell), a master cell group (MCG), or a secondary cell group (SCG). Accordingly, the cell deactivation information may be configured to indicate a deactivated secondary cell, a deactivated primary cell, a deactivated secondary cell group or a deactivated master cell group.

In some implementations, the cell deactivation information may be configured to indicate cell information. The cell information may include any one of: the cell deactivation information being an h-bit resource unit bitmap, where h bits may sequentially correspond to first configured cell information to last configured cell information from a most significant bit to a least significant bit; the cell deactivation information being an h-bit resource unit bitmap, where h bits may sequentially correspond to first configured cell information to last configured cell information from a least significant bit to a most significant bit; or the cell deactivation information being an h-bit cell composite index, where a decimal value of the h bits may correspond to the cell composite index, and the cell composite index may correspond to at least one piece of configured cell information. A value range of h is [0,12]. In addition, a value of h may be an integer not less than 0.

It is to be noted that in a case where a plurality of embodiments or features are separated by “OR,” even if some of the features are not implementable, other embodiments or features will not be affected. In addition, in a case of no conflict, the embodiment of the present disclosure may be combined with other embodiments or implementations related to the method for receiving a wake-up signal for the terminal and their various optional solutions, which will not be repeated here.

In addition, the wake-up signal in the embodiment of the present disclosure may be a low-power wake-up signal, that is, an LP WUS.

According to the embodiment of the present disclosure, after the wake-up signal is received, the present disclosure can change the sleep state of the main radio in the terminal according to the wake-up signal, and can acquire the scheduling information from the wake-up signal. In this way, an entire scheduling delay is shortened. In addition, the embodiment of the present disclosure may acquire the cell deactivation information from the wake-up signal, such that the scheduling information related to the cell deactivation information can be pre-configured, and time for scheduling the cell deactivation information can be saved.

FIG. 7 is a flowchart of a method for receiving a wake-up signal according to yet another embodiment. As shown in FIG. 7, the method may be performed by a terminal and include steps S510 and S520.

Step S510 includes receiving a wake-up signal transmitted by a network device.

Reference can be made to the introduction of the above-described embodiment for the implementation of step S510, which will not be repeated here.

Step S520 includes changing a sleep state of a main radio in the terminal and acquiring reference signal request information, according to the wake-up signal.

In an embodiment of the present disclosure, the terminal may acquire the reference signal request information from the wake-up signal. The reference signal request information is configured to indicate whether to trigger a reference signal. The reference signal may be used for channel measurement, or channel estimation, etc. In addition, bits of the reference signal request information may be 0, 1 or 2 bits.

In some implementations, the reference signal may include any one of: a channel-state information reference signal (CSI-RS), a tracking reference signal (TRS), or a sounding reference signal (SRS).

It is to be noted that in a case where a plurality of embodiments or features are separated by “OR,” even if some of the features are not implementable, other embodiments or features will not be affected. In addition, in a case of no conflict, the embodiment of the present disclosure may be combined with other embodiments or implementations related to the method for receiving a wake-up signal for the terminal and their various optional solutions, which will not be repeated here.

In addition, the wake-up signal in the embodiment of the present disclosure may be a low-power wake-up signal, that is, an LP WUS.

According to the embodiment of the present disclosure, after the wake-up signal is received, the present disclosure can change the sleep state of the main radio in the terminal according to the wake-up signal, and can acquire the scheduling information from the wake-up signal. In this way, an entire scheduling delay is shortened. In addition, the embodiment of the present disclosure may acquire the reference signal request information from the wake-up signal, such that the scheduling information related to the reference signal request information can be pre-configured, and time for scheduling the reference signal request information can be saved.

FIG. 8 is a flowchart of a method for receiving a wake-up signal according to yet another embodiment. As shown in FIG. 8, the method may be performed by a terminal and include steps S610 and S620.

Step S610 includes receiving a wake-up signal transmitted by a network device.

Reference can be made to the introduction of the above-described embodiment for the implementation of step S610, which will not be repeated here.

Step S620 includes changing a sleep state of a main radio in the terminal and acquiring multiple-input multiple-output (MIMO) layer indication information, according to the wake-up signal.

In an embodiment of the present disclosure, the terminal may acquire the MIMO layer indication information from the wake-up signal. The MIMO layer indication information may be configured to indicate a maximum number of MIMO layers (max MIMO layers). In an example, the MIMO layer indication information may alternatively be configured to indicate a number of MIMO layers under a current situation.

It is to be noted that in a case where a plurality of embodiments or features are separated by “OR,” even if some of the features are not implementable, other embodiments or features will not be affected. In addition, in a case of no conflict, the embodiment of the present disclosure may be combined with other embodiments or implementations related to the method for receiving a wake-up signal for the terminal and their various optional solutions, which will not be repeated here.

In addition, the wake-up signal in the embodiment of the present disclosure may be a low-power wake-up signal, that is, an LP WUS.

According to the embodiment of the present disclosure, after the wake-up signal is received, the present disclosure can change the sleep state of the main radio in the terminal according to the wake-up signal, and can acquire the scheduling information from the wake-up signal. In this way, an entire scheduling delay is shortened. In addition, the embodiment of the present disclosure may acquire the MIMO layer indication information from the wake-up signal, such that the scheduling information related to the MIMO layer indication information can be pre-configured, and time for scheduling the MIMO layer indication information can be saved.

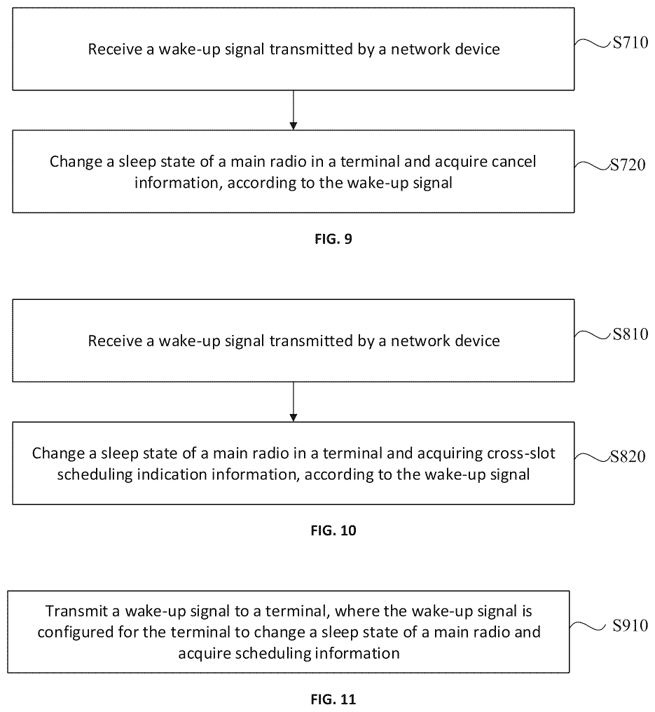

FIG. 9 is a flowchart of a method for receiving a wake-up signal according to yet another embodiment. As shown in FIG. 9, the method may be performed by a terminal and include steps S710 and S720.

Step S710 includes receiving a wake-up signal transmitted by a network device.

Reference can be made to the introduction of the above-described embodiment for the implementation of step S710, which will not be repeated here.

Step S720 includes changing a sleep state of a main radio in the terminal and acquiring cancel information, according to the wake-up signal.

In an embodiment of the present disclosure, the terminal may acquire the cancel information from the wake-up signal. The cancel information may be cancellation of data transmission. The cancel information may include at least one of uplink cancel information or downlink cancel information.

In an example, a function of the uplink cancel information is to indicate cancellation of uplink transmission. In this process, the network device may indicate a transmission resource with higher priority. After receiving this transmission resource, the terminal may cancel the transmission in a case of determining that a current transmission resource conflicts with transmission of the received transmission resource, and the priority of the received transmission resource is higher than priority of the current transmission resource. A function of the downlink cancel information is to indicate cancellation of downlink transmission. The downlink cancel information is similar to the uplink cancel information, and will not be repeated here. In addition, at least one of bits of the uplink cancel information or bits of the uplink cancel information may reach 126 bits.

As an instance, a terminal A is transmitting data on a particular resource, and a terminal B also needs to transmit one piece of data, but priority of the terminal B is higher than priority of the terminal A. In this case, the network device may transmit signaling to the terminal A through the wake-up signal, so as to instruct the terminal A to cancel data transmission, and prioritize the data transmission by the terminal B. After receiving the cancel information transmitted by the network device, the terminal A may cancel its uplink data transmission if any. The cancel information may indicate locations at which the terminal A may transmit data, and may indicate the terminal A to cancel the data transmission in a case where there is an overlap between the locations for data transmission by the terminal A and the locations for data transmission by the terminal B.

It is to be noted that in a case where a plurality of embodiments or features are separated by “OR,” even if some of the features are not implementable, other embodiments or features will not be affected. In addition, in a case of no conflict, the embodiment of the present disclosure may be combined with other embodiments or implementations related to the method for receiving a wake-up signal for the terminal and their various optional solutions, which will not be repeated here.

In addition, the wake-up signal in the embodiment of the present disclosure may be a low-power wake-up signal, that is, an LP WUS.

According to the embodiment of the present disclosure, after the wake-up signal is received, the present disclosure can change the sleep state of the main radio in the terminal according to the wake-up signal, and can acquire the scheduling information from the wake-up signal. In this way, an entire scheduling delay is shortened. In addition, the embodiment of the present disclosure may acquire the cancel information from the wake-up signal, such that the scheduling information related to the cancel information can be pre-configured, and time for scheduling the cancel information can be saved.

FIG. 10 is a flowchart of a method for receiving a wake-up signal according to still another embodiment. As shown in FIG. 10, the method may be performed by a terminal and include steps S810 and S820.

Step S810 includes receiving a wake-up signal transmitted by a network device.

Reference can be made to the introduction of the above-described embodiment for the implementation of step S810, which will not be repeated here.

Step S820 includes changing a sleep state of a main radio in the terminal and acquiring cross-slot scheduling indication information, according to the wake-up signal.

In an embodiment of the present disclosure, the terminal may acquire the cross-slot scheduling indication information according to the wake-up signal. The cross-slot scheduling indication information includes a parameter K0 for indicating a slot situation. The parameter KO indicates a position of a slot where a time domain resource allocated by the network device to the terminal is located. The parameter KO may be a slot where a physical downlink control channel (PDCCH) is received.

In some implementations, the parameter K0 may indicate a slot where the terminal receives downlink data or transmits uplink data after receiving the WUS. In an example, the parameter K0 may equal 0, 1 or 2. The parameter K0 of 0 indicates a slot where the PDCCH is received with scheduling on a current slot. The parameter K0 of 1 indicates that scheduling is on a next slot. The parameter K0 of 2 indicates that scheduling is on a slot after the next slot. In addition, the slot in the embodiment of the present disclosure may be a slot where the WUS is located. The embodiment of the present disclosure may receive the slot according to the LP WUS.

It is to be noted that in a case where a plurality of embodiments or features are separated by “OR,” even if some of the features are not implementable, other embodiments or features will not be affected. In addition, in a case of no conflict, the embodiment of the present disclosure may be combined with other embodiments or implementations related to the method for receiving a wake-up signal for the terminal and their various optional solutions, which will not be repeated here.

In addition, the wake-up signal in the embodiment of the present disclosure may be a low-power wake-up signal, that is, an LP WUS.

According to the embodiment of the present disclosure, after the wake-up signal is received, the present disclosure can change the sleep state of the main radio in the terminal according to the wake-up signal, and can acquire the scheduling information from the wake-up signal. In this way, an entire scheduling delay is shortened. In addition, the embodiment of the present disclosure may acquire the cross-slot scheduling indication information from the wake-up signal, such that the scheduling information related to the cross-slot scheduling indication information can be pre-configured, and time for scheduling the cross-slot scheduling indication information can be saved.

FIG. 11 is a flowchart of a method for transmitting a wake-up signal according to an embodiment. As shown in FIG. 11, the method may be performed by a network device and include step S910.

Step S910 includes transmitting a wake-up signal to a terminal, where the wake-up signal is configured for the terminal to change a sleep state of a main radio and acquire scheduling information.

In some implementations, the wake-up signal transmitted by the network device to the terminal may include the scheduling information. The scheduling information may include power control information. The power control information is configured to indicate transmission power of an uplink channel. The uplink channel may include at least one of a PUCCH or a PUSCH.

In some other implementations, the scheduling information may further include bandwidth part indication information. A target indicated by the bandwidth part indication information includes at least one of an uplink bandwidth part or a downlink bandwidth part. In an example, at least one of a number of the uplink bandwidth parts or a number of the downlink bandwidth parts may be M. The M bandwidth parts include any one of: the M bandwidth parts including an initial bandwidth part; or the M bandwidth parts not including the initial bandwidth part.

In an example, when the terminal initially accesses the network, the network device may configure a small bandwidth for the terminal, such that the terminal may receive data transmitted by the network. Such a bandwidth part may be referred to as the initial bandwidth part.

In an implementation, in a case where the terminal does not access the network or the terminal has just accessed the network, the network device usually indicates the initial bandwidth part in a case of indicating a bandwidth for the terminal. Thus, the M bandwidth parts may include the initial bandwidth part.

In another implementation, after the terminal accesses the network, the network device re-configures a bandwidth for the terminal for demand for a service, so as to adapt to different service scenarios. In a case where the terminal accesses the network for a long time, the terminal is usually not switched to the initial bandwidth part for transmission. Thus, the M bandwidth parts may not include the initial bandwidth part.

In an embodiment of the present disclosure, the bandwidth part indication information may be configured to indicate any one of: the bandwidth part indication information being an n-bit resource unit bitmap, where each bit may correspond to one configured bandwidth part, and n bits may sequentially correspond to a first configured bandwidth part to a last configured bandwidth part from a most significant bit to a least significant bit; the bandwidth part indication information being an m-bit bandwidth composite index, where a decimal value of the m bits may correspond to the bandwidth composite index, and the bandwidth composite index may correspond to at least one configured bandwidth part; or the bandwidth part indication information being an N-bit resource unit bitmap, where N may indicate a maximum number of bandwidth parts configured for the terminal, and first k of N bits may sequentially correspond to a first actually configured bandwidth part to a last actually configured bandwidth part from a most significant bit to a least significant bit, where N is not less than k.

In some other implementations, the scheduling information may further include cell deactivation information. The cell deactivation information is configured to indicate any one of the following information: a primary cell, a secondary cell, a primary secondary cell, a master cell group, or a secondary cell group.

In an example, the cell deactivation information is configured to indicate cell information. The cell information may include any one of: the cell deactivation information being an h-bit resource unit bitmap, where h bits sequentially correspond to first configured cell information to last configured cell information from a most significant bit to a least significant bit; the cell deactivation information being an h-bit resource unit bitmap, where h bits sequentially correspond to first configured cell information to last configured cell information from a least significant bit to a most significant bit or the cell deactivation information being an h-bit cell composite index, where a decimal value of the h bits corresponds to the cell composite index, and the cell composite index corresponds to at least one piece of configured cell information.

In some other implementations, the scheduling information may further include reference signal request information. The reference signal request information is configured to indicate whether to trigger a reference signal. The reference signal may include any one of: a CSI-RS, a TRS, or an SRS.

In some other implementations, the scheduling information may further include MIMO layer indication information. The MIMO layer indication information may be configured to indicate a maximum number of MIMO layers or may be configured to indicate a number of MIMO layers under a current situation.

In some other implementations, the scheduling information may further include cancel information. The cancel information may include at least one of uplink cancel information or downlink cancel information.

In some other implementations, the scheduling information may further include cross-slot scheduling indication information. The cross-slot scheduling indication information may include a parameter K0 for indicating a slot situation. The parameter K0 may indicate a slot where the terminal receives downlink data or transmits uplink data after receiving the WUS. The parameter K0 may equal 0, 1 or 2.

It is to be noted that in a case where a plurality of embodiments or features are separated by “OR,” even if some of the features are not implementable, other embodiments or features will not be affected. In addition, in a case of no conflict, the embodiment of the present disclosure may be combined with the embodiments or implementations related to the method for receiving a wake-up signal for the terminal and their various optional solutions, which will not be repeated here.

In addition, the wake-up signal in the embodiment of the present disclosure may be a low-power wake-up signal, that is, an LP WUS.

In an embodiment of the present disclosure, the network device may transmit the wake-up signal to the terminal. Through this wake-up signal, the network device may instruct the terminal to change the sleep state of the main radio of the terminal, and may further instruct the terminal to acquire the scheduling information, such that the entire scheduling delay can be shortened. In addition, in the embodiment of the present disclosure, the network device may pre-configure the terminal through the LP WUS, such that accuracy of subsequent scheduling information configuration can be improved, and user experience can be further improved.

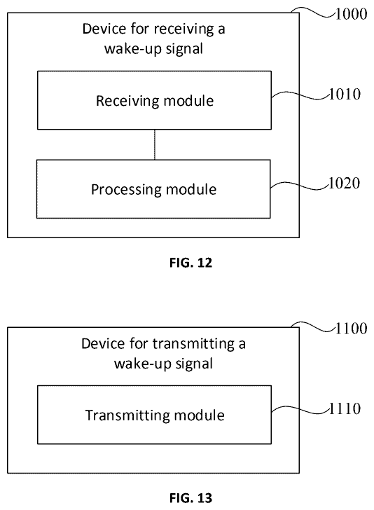

FIG. 12 is a block diagram of a device 1000 for receiving a wake-up signal according to an embodiment. With reference to FIG. 12, the device 1000 for receiving a wake-up signal may include a receiving module 1010 and a processing module 1020.

The receiving module 1010 is configured to receive a wake-up signal transmitted by a network device.

The processing module 1020 is configured to change a sleep state of a main radio in a terminal and acquire scheduling information, according to the wake-up signal.

In some implementations, the scheduling information includes any one of:
power control information, where the power control information is configured to indicate transmission power of an uplink channel, and the uplink channel includes at least one of a PUCCH or a PUSCH;
bandwidth part indication information, where the bandwidth part indication information is configured to indicate at least one of an uplink bandwidth part or a downlink bandwidth part;
cell deactivation information;
reference signal request information, where the reference signal request information is configured to indicate whether to trigger a reference signal;
MIMO layer indication information;
cancel information; or
cross-slot scheduling indication information.

In some implementations, the bandwidth part indication information is further configured to indicate any one of:
the bandwidth part indication information being an n-bit resource unit bitmap, where each bit of the bitmap corresponds to one configured bandwidth part, and n bits sequentially correspond to a first configured bandwidth part to a last configured bandwidth part from a most significant bit to a least significant bit;
the bandwidth part indication information being an m-bit bandwidth composite index, where a decimal value of the m bits corresponds to the bandwidth composite index, and the bandwidth composite index corresponds to at least one configured bandwidth part; or
the bandwidth part indication information being an N-bit resource unit bitmap, where N indicates a maximum number of bandwidth parts configured for the terminal, and first k of N bits sequentially correspond to a first actually configured bandwidth part to a last actually configured bandwidth part from a most significant bit to a least significant bit, where N is not less than k, and a value range of each of n, m, N and k is [0,16].

In some implementations, the cell deactivation information is configured to indicate any one of the following information:
a primary cell;
a secondary cell;
a primary secondary cell;
a master cell group; or
a secondary cell group.

In some implementations, the cell deactivation information is configured to indicate cell information. The cell information includes any one of:
the cell deactivation information being an h-bit resource unit bitmap, where h bits sequentially correspond to first configured cell information to last configured cell information from a most significant bit to a least significant bit, and a value range of h is [0,12];
the cell deactivation information being an h-bit resource unit bitmap, where h bits sequentially correspond to first configured cell information to last configured cell information from a least significant bit to a most significant bit; or
the cell deactivation information being an h-bit cell composite index, where a decimal value of the h bits corresponds to the cell composite index, and the cell composite index corresponds to at least one piece of configured cell information.

In some implementations, the MIMO layer indication information is configured to indicate a maximum number of MIMO layers; or
a number of MIMO layers under a current situation.

In some implementations, the cross-slot scheduling indication information includes a parameter K0 for indicating a slot situation. The parameter K0 indicates a slot where the terminal receives downlink data or transmits uplink data after receiving the WUS. The parameter K0 equals 0, 1 or 2.

According to the embodiment of the present disclosure, after the wake-up signal is received, the present disclosure can change the sleep state of the main radio in the terminal according to the wake-up signal, and can acquire the scheduling information from the wake-up signal. In this way, an entire scheduling delay is shortened.

FIG. 13 is a block diagram of a device 1100 for transmitting a wake-up signal according to an embodiment. With reference to FIG. 13, the device 1100 for transmitting a wake-up signal may include a transmitting module 1110.

The transmitting module 1110 is configured to transmit a wake-up signal to a terminal. The wake-up signal is configured for the terminal to change a sleep state of a main radio and acquire scheduling information.

In some implementations, the scheduling information includes any one of:
power control information, where the power control information is configured to indicate transmission power of an uplink channel, and the uplink channel includes at least one of a PUCCH or a PUSCH;
bandwidth part indication information, where the bandwidth part indication information is configured to indicate at least one of an uplink bandwidth part or a downlink bandwidth part;
cell deactivation information;
reference signal request information, where the reference signal request information is configured to indicate whether to trigger a reference signal;
MIMO layer indication information;
cancel information; or
cross-slot scheduling indication information.

In the embodiment of the present disclosure, the network device may transmit the wake-up signal to the terminal. Through this wake-up signal, the network device may instruct the terminal to change the sleep state of the main radio of the terminal, and may further instruct the terminal to acquire the scheduling information, such that the entire scheduling delay can be shortened.

With respect to the device in the above-described embodiment, manners by which the modules perform operations have been described in detail in the embodiments relating to the method, and will not be described in detail here.

The present disclosure further provides a non-transitory computer-readable storage medium. The non-transitory computer-readable storage medium stores computer program instructions. The computer program instructions, when collectively executed by one or more processors, cause the one or more processors to perform steps of the method for receiving a wake-up signal and steps of the method for transmitting a wake-up signal according to the present disclosure.

The present disclosure further provides a communication system (not shown). The communication system may include a terminal and a network device. The terminal may perform steps of the method for receiving a wake-up signal related to the terminal in the embodiment. The network device may perform steps of the method for transmitting a wake-up signal related to the network device in the embodiment.

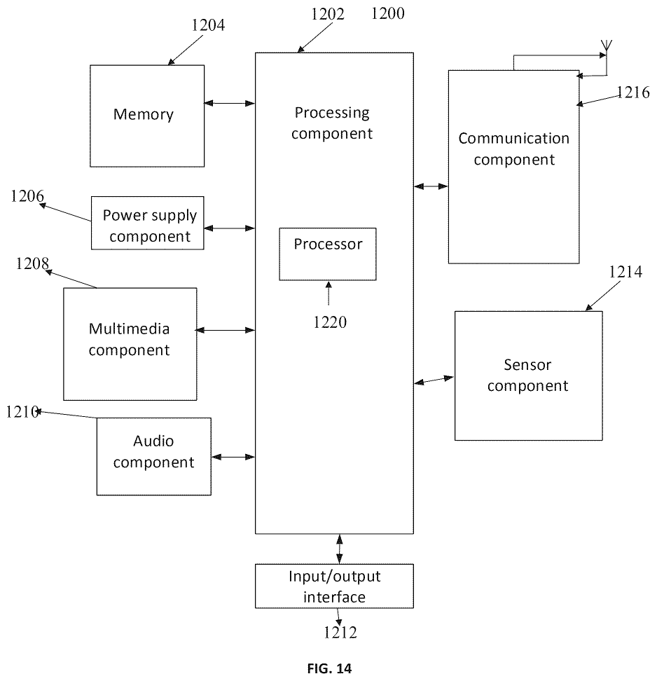

FIG. 14 is a block diagram of a communication device 1200 according to an embodiment. The communication device 1200 may be a terminal. For example, the communication device 1200 may be a mobile phone, a computer, a digital broadcast terminal, a message transmitting and receiving device, a game console, a portable android device, a medical device, a fitness device, a personal digital assistant, a smart car, etc.

With reference to FIG. 14, the communication device 1200 may include one or more of a processing component 1202, a memory 1204, a power supply component 1206, a multimedia component 1208, an audio component 1210, an input/output interface 1212, a sensor component 1214, and a communication component 1216.

Generally, the processing component 1202 controls an overall operation of the communication device 1200, such as an operation associated with display, a telephone call, data communication, a camera operation, and a recording operation. The processing component 1202 may include one or more processors 1220 to execute instructions, so as to complete all or some of steps of the method for receiving a wake-up signal and steps of the method for transmitting a wake-up signal. In addition, the processing component 1202 may include one or more modules for interaction between the processing component 1202 and another component. For example, the processing component 1202 may include a multimedia module (not shown) for interaction between the multimedia component 1208 and the processing component 1202.

The memory 1204 is configured to store various types of data to support the operation of the communication device 1200. Instances of these data include instructions, contact data, phonebook data, messages, pictures, video, etc. of any application or method operated on the communication device 1200. The memory 1204 may be implemented by any type of volatile or non-volatile storage devices or their combinations, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk, and an optical disk.

The power supply component 1206 energizes various components of the communication device 1200. The power supply component 1206 may include a power management system, one or more power supplies, and other components associated with power generation, management, and distribution for the communication device 1200.

The multimedia component 1208 includes a screen providing an output interface between the communication device 1200 and a user. In an embodiment, the screen may include a liquid crystal display (LCD) and a touch panel (TP). In a case where the screen includes the touch panel, the screen may be implemented as a touch screen to receive an input signal from the user. The touch panel includes one or more touch sensors to sense touch, swipe, and a gesture on the touch panel. The touch sensor may not only sense a boundary of a touch or swipe action, but also measure duration and a pressure associated with the touch or swipe operation. In an embodiment, the multimedia component 1208 includes at least one of a front-facing camera or a rear-facing camera. When the communication device 1200 is in an operational mode, such as, a photographing mode or a video mode, at least one of the front-facing camera or the rear-facing camera may receive external multimedia data. Each of the front-facing camera and the rear-facing camera may be one fixed-focus optical lens system or have a focal length and an optical zoom capacity.

The audio component 1210 is configured to output and/or input an audio signal. For example, the audio component 1210 includes a microphone (MIC). The microphone is configured to receive an external audio signal when the communication device 1200 is in the operation mode, such as a call mode, a recording mode, and a voice recognition mode. The audio signal received may be further stored in the memory 1204 or transmitted through the communication component 1216. In an embodiment, the audio component 1210 further includes a speaker configured to output the audio signal.

The input/output interface 1212 provides an interface between the processing component 1202 and a peripheral interface module. The peripheral interface module may be a keyboard, a click wheel, a button, etc. These buttons may include, but are not limited to a home button, a volume button, a start button, and a lock button.

The sensor component 1214 includes one or more sensors configured to provide state assessments in various aspects for the communication device 1200. For example, the sensor component 1214 may detect an on/off state of the communication device 1200, and relative positioning of components. For example, the components are a display and a keypad of the communication device 1200. The sensor component 1214 may further detect a change in position of the communication device 1200 or a component of the communication device 1200, presence or absence of contact between the user and the communication device 1200, orientation or acceleration/deceleration of the communication device 1200, and temperature change of the communication device 1200. The sensor component 1214 may include a proximity sensor configured to detect the presence of a nearby object in the absence of any physical contact. The sensor component 1214 may further include an optical sensor, such as a complementary metal-oxide-semiconductor transistor (CMOS) or charge-coupled device (CCD) image sensor for use in an imaging application. In an embodiment, the sensor component 1214 may further include an acceleration sensor, a gyroscope sensor, a magnetic sensor, a pressure sensor, or a temperature sensor.

The communication component 1216 is configured to facilitate wired or wireless communication between the communication device 1200 and another device. The communication device 1200 may access a wireless network based on a communication standard, such as WiFi, 2G or 3G, or their combinations. In an example, the communication component 1216 receives a broadcast signal or broadcast related information from an external broadcast management system via a broadcast channel. In an example, the communication component 1216 further includes a near field communication (NFC) module to promote short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In an example, the communication device 1200 may be implemented by one or more application specific integrated circuits (ASICs), digital signal processors (DSPs), digital signal processing devices (DSPDs), programmable logic devices (PLDs), field programmable gate arrays (FPGAs), controllers, microcontrollers, microprocessors, or other electronic components for performing the method for receiving a wake-up signal and the method for transmitting a wake-up signal.

In an example, a non-transitory computer-readable storage medium including instructions, for example, a memory 1204 including instructions, is further provided. The instructions, when executed by the processor 1220 of the communication device 1200, may implement the method for receiving a wake-up signal and the method for transmitting a wake-up signal. For example, the non-transitory computer-readable storage medium may be an ROM, a random-access memory (RAM), a compact disc read-only memory (CD-ROM), a magnetic tape, a floppy disc, an optical data storage device, etc.

The device in the disclosure may be a separate electronic device or a part of a separate electronic device. For example, the device may be an integrated circuit (IC) or a chip. The integrated circuit may be one IC or a set of a plurality of ICs. The chip may include, but is not limited to, the following categories: a graphics processing unit (GPU), a central processing unit (CPU), a field programmable gate array (FPGA), a digital signal processor (DSP), an application specific integrated circuit (ASIC), a system on chip (SOC), etc. The integrated circuit or chip may be configured to execute executable instructions (or codes), so as to implement the method for receiving a wake-up signal and the method for transmitting a wake-up signal. The executable instructions may be stored in the integrated circuit or the chip or may be acquired from other apparatuses or devices. For example, the integrated circuit or the chip includes a processor, a memory, and interfaces for communicating with other devices. The executable instructions may be stored in the memory. The executable instructions, when executed by the processor, implement the method for receiving a wake-up signal and the method for transmitting a wake-up signal. Alternatively, the integrated circuit or the chip may receive the executable instructions through the interface and transmit the executable instructions to the processor for being executed, so as to implement the method for receiving a wake-up signal and the method for transmitting a wake-up signal.

In another example, a computer program product is further provided. The computer program product includes a computer program executable by a programmable device. The computer program has code portions. The code portions, when executed by the programmable device, perform the method for receiving a wake-up signal and the method for transmitting a wake-up signal.

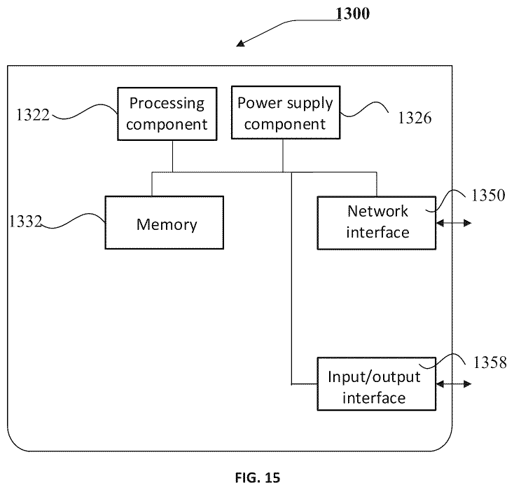

FIG. 15 is a block diagram of a communication device 1300 according to an example. The communication device 1300 may be a network device. For example, the communication device 1300 may be provided as a server. With reference to FIG. 15, the communication device 1300 includes: a processing component 1322, further including one or more processors (not shown); and a memory resource denoted by a memory 1332 and configured to store instructions, such as applications executable by the processing component 1322. The applications stored in the memory 1332 may include one or more modules each corresponding to a set of instructions. Further, the processing component 1322 is configured to execute the instructions to perform the method for receiving a wake-up signal and the method for transmitting a wake-up signal.

The communication device 1300 may further include a power supply component 1326 configured to perform power management of the communication device 1300, a wired or wireless network interface 1350 configured to connect the communication device 1300 to a network, and an input/output interface 1358. The communication device 1300 may operate an operation system stored in the memory 1332, such as Windows Server™, Mac OS X™, Unix™, Linux™, and FreeBSD™.

As used herein, the term “processor” may refer to one processor that performs the defined functions or a plurality of processors that collectively perform defined functions, such that the execution of the individual defined functions may be divided amongst such processors.

A person of ordinary skill in the art will readily conceive of other implementation solutions of the present disclosure after considering the description and implementing the present disclosure. The present disclosure intends to cover any variation, use or adaptive change of the present disclosure that follows general principles of the present disclosure and includes common general knowledge or conventional technical means in the technical field that are not disclosed in the present disclosure. The description and the embodiments are merely considered illustrative, and a true scope and spirit of the present disclosure are indicated by the following claims.

It is to be understood that the present disclosure is not limited to precise structures described in the disclosure and shown in the accompanying drawings, and various modifications and changes can be made without departing from the scope of the present disclosure. The scope of the present disclosure is merely limited by the appended claims.

1. A method for receiving a wake-up signal, performed by a terminal, the method comprising:
receiving a wake-up signal transmitted by a network device; and
changing a sleep state of a main radio in the terminal and acquiring scheduling information, according to the wake-up signal.

2. The method according to claim 1, wherein the scheduling information comprises any one of the following:
power control information, wherein the power control information is configured to indicate transmission power of an uplink channel, and the uplink channel comprises at least one of a physical uplink control channel (PUCCH) or a physical uplink shared channel (PUSCH);
bandwidth part indication information, wherein the bandwidth part indication information is configured to indicate at least one of an uplink bandwidth part or a downlink bandwidth part;
cell deactivation information;
reference signal request information, wherein the reference signal request information is configured to indicate whether to trigger a reference signal;
multiple-input multiple-output (MIMO) layer indication information;
cancel information; or
cross-slot scheduling indication information.

3. The method according to claim 2, wherein the bandwidth part indication information is further configured to indicate any one of the following:
the bandwidth part indication information being an n-bit resource unit bitmap, wherein each bit of the n-bit resource unit bitmap corresponds to one configured bandwidth part, and the n bits sequentially correspond to a first configured bandwidth part to a last configured bandwidth part from a most significant bit to a least significant bit;
the bandwidth part indication information being an m-bit bandwidth composite index, wherein a decimal value of the m bits corresponds to the m-bit bandwidth composite index, and the m-bit bandwidth composite index corresponds to at least one configured bandwidth part; or
the bandwidth part indication information being an N-bit resource unit bitmap, wherein N indicates a maximum number of bandwidth parts configured for the terminal, and first k of the N bits sequentially correspond to a first actually configured bandwidth part to a last actually configured bandwidth part from a most significant bit to a least significant bit, wherein N is not less than k, and a value range of each of n, m, N and k is [0,16].

4. The method according to claim 2, wherein the cell deactivation information is configured to indicate any one of the following:
a primary cell;
a secondary cell;
a primary secondary cell;
a master cell group; or
a secondary cell group.

5. The method according to claim 2, wherein the cell deactivation information is configured to indicate cell information, and the cell information comprises any one of the following:
the cell deactivation information being an h-bit resource unit bitmap, wherein the h bits sequentially correspond to first configured cell information to last configured cell information from a most significant bit to a least significant bit, and a value range of h is [0,12];
the cell deactivation information being an h-bit resource unit bitmap, wherein the h bits sequentially correspond to first configured cell information to last configured cell information from a least significant bit to a most significant bit; or
the cell deactivation information being an h-bit cell composite index, wherein a decimal value of the h bits corresponds to the h-bit cell composite index, and the h-bit cell composite index corresponds to at least one piece of configured cell information.

6. The method according to claim 2, wherein the MIMO layer indication information is configured to indicate a maximum number of MIMO layers; or a number of MIMO layers under a current situation.

7. The method according to claim 2, wherein the cross-slot scheduling indication information comprises a parameter K0 for indicating a slot situation, the parameter K0 indicates a slot where the terminal receives downlink data or transmits uplink data after receiving the wake-up signal, and the parameter K0 equals 0, 1 or 2.

8. A method for transmitting a wake-up signal, performed by a network device, the method comprising:
transmitting the wake-up signal to a terminal, wherein the wake-up signal is configured for the terminal to change a sleep state of a main radio and acquire scheduling information.

9. The method according to claim 8, wherein the scheduling information comprises any one of the following:
power control information, wherein the power control information is configured to indicate transmission power of an uplink channel, and the uplink channel comprises at least one of a physical uplink control channel (PUCCH) or a physical uplink shared channel (PUSCH);
bandwidth part indication information, wherein the bandwidth part indication information is configured to indicate at least one of an uplink bandwidth part or a downlink bandwidth part;
cell deactivation information;
reference signal request information, wherein the reference signal request information is configured to indicate whether to trigger a reference signal;
multiple-input multiple-output (MIMO) layer indication information;
cancel information; or
cross-slot scheduling indication information.

10-11. (canceled)

12. A communication device, comprising:
one or more processors; and
a memory configured to store processor-executable instructions;
wherein the one or more processors are collectively configured to execute the processor-executable instructions, so as to cause the communication device to act as the terminal and perform the method according to claim 1.

13. A communication device, comprising:
one or more processors; and
a memory configured to store processor-executable instructions;
wherein the one or more processors are collectively configured to execute the processor-executable instructions, so as to cause the communication device to act as the network device and perform the method according to claim 8.

14. A communication system, comprising a terminal and a network device, wherein:
the terminal, configured to receive a wake-up signal transmitted by the network device, and to change a sleep state of a main radio in the terminal and acquire scheduling information, according to the wake-up signal; and
the network device, configured to transmit the wake-up signal to the terminal.

15. A non-transitory computer-readable storage medium, storing computer program instructions, wherein the computer program instructions, when collectively executed by one or more processors of the terminal, cause the terminal to perform the method according to claim 1.

16. The method according to claim 9, wherein the bandwidth part indication information is further configured to indicate any one of the following:
the bandwidth part indication information being an n-bit resource unit bitmap, wherein each bit of the n-bit resource unit bitmap corresponds to one configured bandwidth part, and the n bits sequentially correspond to a first configured bandwidth part to a last configured bandwidth part from a most significant bit to a least significant bit;
the bandwidth part indication information being an m-bit bandwidth composite index, wherein a decimal value of the m bits corresponds to the m-bit bandwidth composite index, and the m-bit bandwidth composite index corresponds to at least one configured bandwidth part; or
the bandwidth part indication information being an N-bit resource unit bitmap, wherein N indicates a maximum number of bandwidth parts configured for the terminal, and first k of the N bits sequentially correspond to a first actually configured bandwidth part to a last actually configured bandwidth part from a most significant bit to a least significant bit, wherein N is not less than k, and a value range of each of n, m, N and k is [0,16].

17. The method according to claim 9, wherein the cell deactivation information is configured to indicate any one of the following:
a primary cell;
a secondary cell;
a primary secondary cell;
a master cell group; or
a secondary cell group.

18. The method according to claim 9, wherein the cell deactivation information is configured to indicate cell information, and the cell information comprises any one of:
the cell deactivation information being an h-bit resource unit bitmap, wherein the h bits sequentially correspond to first configured cell information to last configured cell information from a most significant bit to a least significant bit, and a value range of h is [0,12];
the cell deactivation information being an h-bit resource unit bitmap, wherein the h bits sequentially correspond to first configured cell information to last configured cell information from a least significant bit to a most significant bit; or
the cell deactivation information being an h-bit cell composite index, wherein a decimal value of the h bits corresponds to the h-bit cell composite index, and the h-bit cell composite index corresponds to at least one piece of configured cell information.

19. The method according to claim 9, wherein the MIMO layer indication information is configured to indicate a maximum number of MIMO layers; or a number of MIMO layers under a current situation.

20. The method according to claim 9, wherein the cross-slot scheduling indication information comprises a parameter K0 for indicating a slot situation, the parameter K0 indicates a slot where the terminal receives downlink data or transmits uplink data after receiving the wake-up signal, and the parameter K0 equals 0, 1 or 2.

21. A non-transitory computer-readable storage medium, storing computer program instructions, wherein the computer program instructions, when collectively executed by one or more processors of the network device, cause the network device to perform the method according to claim 8.
